(19) United States
(12) Patent Application Publication
(10) Pub. No.: US 2026/0319426 A1
(43) Pub. Date: Oct. 15, 2026

(54) IMAGE FORMING APPARATUS

(71) Applicant: KYOCERA Document Solutions Inc., Osaka-shi (JP)

(72) Inventor: Masaru Takagi, Osaka (JP)

(21) Appl. No.: 19/467,131

(22) Filed: Feb. 2, 2026

(30) Foreign Application Priority Data
Feb. 12, 2025 (JP) 2025-020598

(51) Int. Cl. G03G 21/16

(52) U.S. Cl. CPC G03G 21/1619

(57) ABSTRACT

A reinforcing member is fixed to a part of joined square pipes. The plurality of square pipes include a first column pipe, a second column pipe, a first beam pipe, and a second beam pipe. The first beam pipe is joined to a lower end portion of the first column pipe and a lower end portion of the second column pipe. The second beam pipe is joined to the first column pipe and the second column pipe above the first beam pipe. The reinforcing member has a pair of beam contact portions and a connecting portion. The pair of beam contact portions contact an upper surface of the first beam pipe and a lower surface of the second beam pipe, respectively. The connecting portion is connected to the pair of beam contact portions via a pair of first bent portions.

### INCORPORATION BY REFERENCE

This application is based upon and claims the benefit of priority from the corresponding Japanese Patent Application No. 2025-020598 filed on Feb. 12, 2025, the entire contents of which are incorporated herein by reference.

### BACKGROUND

The present disclosure relates to an image forming apparatus having a structure including a plurality of joined square pipes.

Devices that make up the image forming apparatus are supported by the structure that forms a framework of the image forming apparatus. The image forming apparatus includes a printing device that forms an image on a sheet.

For example, a structure including a plurality of square pipes joined by welding is known. The structure having such a configuration has high strength.

### SUMMARY

An image forming apparatus according to an aspect of the present disclosure includes a printing device and a structure. The printing device forms an image on a sheet. The structure internally houses the printing device. The structure includes a plurality of joined square pipes and a reinforcing member that is a sheet metal member fixed to a part of the plurality of square pipes. The plurality of square pipes include a first column pipe and a second column pipe each arranged along a vertical direction, a first beam pipe and a second beam pipe. The first beam pipe is joined to a lower end portion of the first column pipe and a lower end portion of the second column pipe. The second beam pipe is joined to the first column pipe and the second column pipe above the first beam pipe. The reinforcing member has a pair of plate-shaped beam contact portions and a plate-shaped connecting portion. The pair of beam contact portions contact an upper surface of the first beam pipe and a lower surface of the second beam pipe, respectively. The connecting portion is connected to the pair of beam contact portions via a pair of first bent portions that extend along a lengthwise direction of the first beam pipe and the second beam pipe.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram showing a configuration of an image forming apparatus according to an embodiment.

FIG. 2 is a perspective view of a structure of an image forming apparatus according to an embodiment.

FIG. 3 is a perspective view of a periphery of a lower end of a structure in an image forming apparatus according to an embodiment.

FIG. 4 is a perspective view of a reinforcing member in an image forming apparatus according to an embodiment.

### DETAILED DESCRIPTION

Hereinafter, an embodiment according to the present disclosure will be described with reference to the drawings. Note that the following embodiments are examples of a specific embodiment according the present disclosure, and do not limit the technical scope of the present disclosure.

### Configuration of Image Forming Apparatus 10

An image forming apparatus 10 according to an embodiment includes a main body unit 1 and an image reading unit 2.

The main body unit 1 includes a sheet storage unit 30, a sheet conveying device 3, a printing device 4, and a structure 6. The image reading unit 2 is connected to an upper portion of the main body unit 1. The image reading unit 2 is a device that reads an image of a document.

The sheet storage unit 30 stores a plurality of sheets 9. The sheet conveying device 3 feeds out the sheets 9 in the sheet storage unit 30 one by one to the sheet conveying path 300. Furthermore, the sheet conveying device 3 conveys the sheet 9 along the sheet conveying path 300 by a plurality of sets of conveying roller pairs 31.

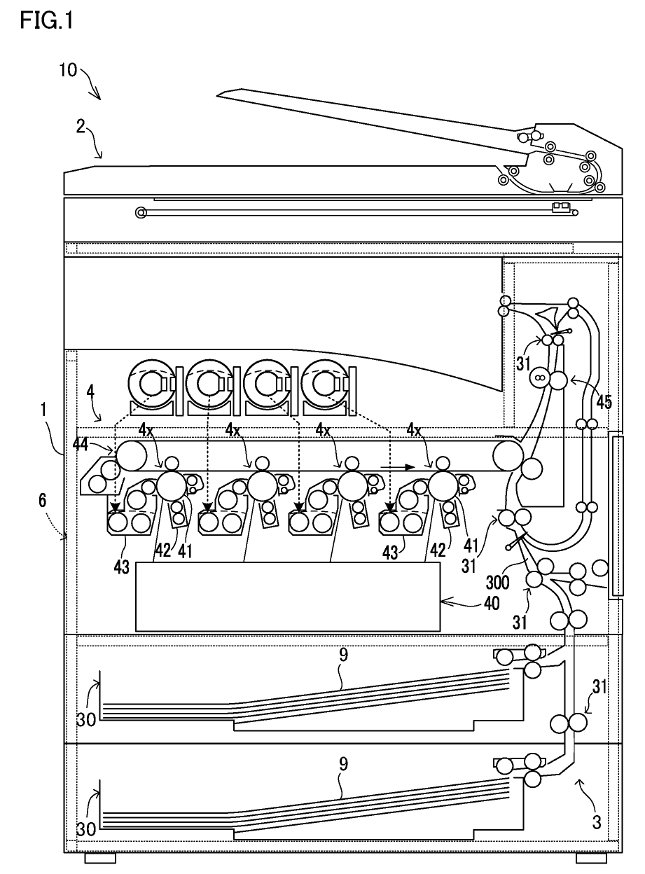

The printing device 4 forms an image on a sheet 9 conveyed along the sheet conveying path 300. In the example shown in FIG. 1, the printing device 4 forms an image on a sheet 9 by electrophotography. The sheet 9 is a sheet-like image forming medium such as paper or a resin sheet.

The electrophotographic printing device 4 includes a laser scanning unit 40, one or more image forming portions 4x, a transfer device 44, and a fixing device 45.

In the example shown in FIG. 1, the printing device 4 is a tandem color image printing device. Therefore, the printing device 4 has four image forming portions 4x corresponding to the four colors of toner: yellow, magenta, cyan, and black.

In each image forming portion 4x, a drum-shaped photoconductor 41 rotates, and a charging device 42 charges an outer peripheral surface of the photoconductor 41. Furthermore, the laser scanning unit 40 writes an electrostatic latent image on the outer peripheral surface of the photoconductor 41, and the developing device 43 develops the electrostatic latent image into a toner image.

Furthermore, in the transfer device 44, an intermediate transfer belt 440 rotates while coming in contact with four photoconductors 41, and four primary transfer devices 441 corresponding to the four image forming portions 4x transfer the toner images onto the intermediate transfer belt 440. Furthermore, a secondary transfer device 442 transfers the toner image on the intermediate transfer belt 440 onto the sheet 9 being conveyed along the sheet conveying path 300.

The fixing device 45 fixes the toner image on the sheet 9 by applying heat and pressure to the toner image on the sheet 9. The sheet conveying device 3 discharges the sheet 9 on which the image is formed from the sheet conveying path 300.

Note that the printing device 4 may be a device that forms an image on the sheet 9 by a method other than the electrophotographic method, such as an inkjet method.

The sheet conveying device 3 and the printing device 4 are supported within and by the structure 6. That is, the structure 6 includes the sheet conveying device 3 and the printing device 4 therein. The image reading unit 2 is connected to an upper portion of the structure 6.

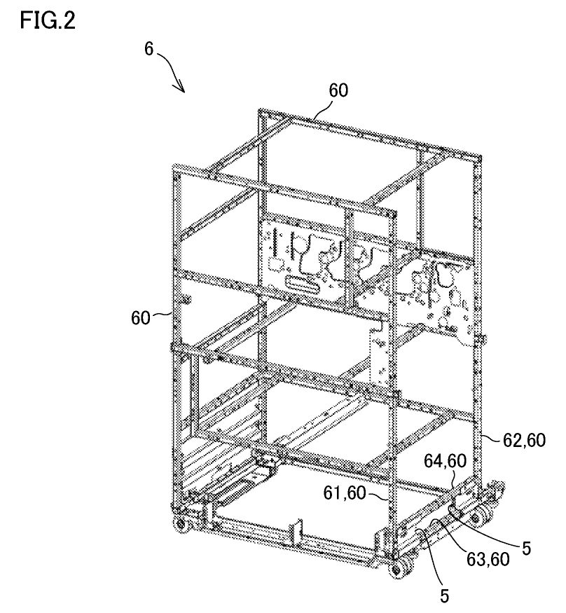

The structure 6 includes a plurality of joined square pipes 60 (see FIG. 2). In the structure 6, a plurality of metal square pipes 60 are joined by welding. Such a structure 6 has high strength.

In order to reduce weight of the structure 6, it is desirable to use square pipes 60 that are as thin as possible. On the other hand, a lower end portion of the structure 6 is required to have high strength since the lower end portion receives a larger load than other parts.

For example, in a case in which the image forming apparatus 10 is dropped during transportation, the lower end portion of the structure 6 is likely to bend due to a large external force including weight of the image forming apparatus 10.

In the image forming apparatus 10, the structure 6 is made lighter by using relatively thin square pipes 60. This structure 6 has a feature for increasing strength of the lower end portion of the structure 6 with a simple configuration.

### Configuration of Structure 6

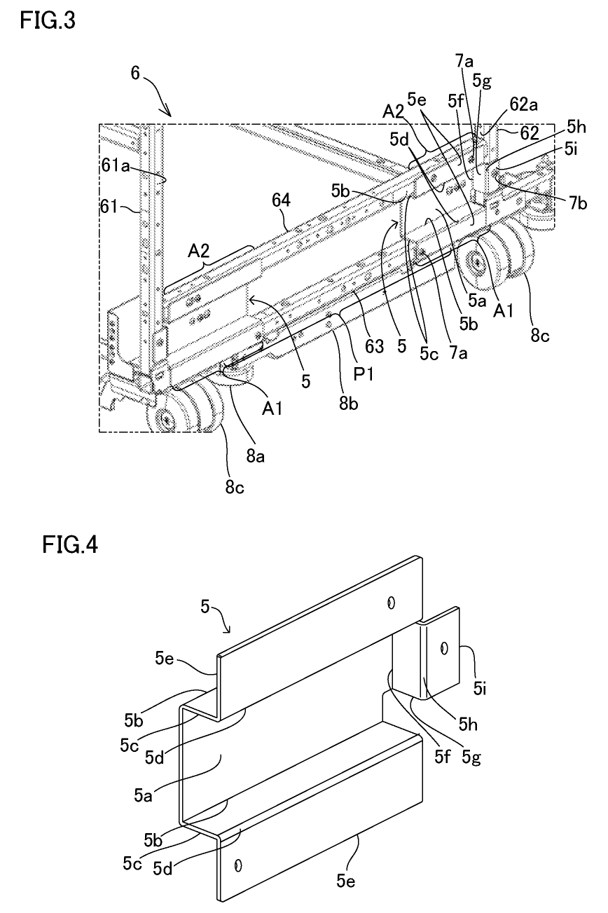

The structure 6 includes a plurality of joined square pipes 60 and a reinforcing member 5 fixed to a part of the plurality of square pipes 60 (see FIGS. 2 and 3). The reinforcing member 5 is a bent sheet metal member (see FIGS. 3 and 4).

The plurality of square pipes 60 include a first column pipe 61 and a second column pipe 62 that are each arranged along a vertical direction (see FIGS. 2 and 3). Furthermore, the plurality of square pipes 60 includes a first beam pipe 63 and a second beam pipe 64 (see FIGS. 2 and 3).

The first beam pipe 63 is joined to a lower end portion of the first column pipe 61 and a lower end portion of the second column pipe 62 by welding. In the present embodiment, a lower surface of the first column pipe 61 and a lower surface of the second column pipe 62 are in contact with an upper surface of the first beam pipe 63. That is, the lower end portion of the first column pipe 61 and the lower end portion of the second column pipe 62 are arranged on the upper surface of the first beam pipe 63.

The second beam pipe 64 is joined by welding to the first column pipe 61 and the second column pipe 62 above the first beam pipe 63. The first beam pipe 63 and the second beam pipe 64 are arranged vertically side by side. In the present embodiment, the first beam pipe 63 and the second beam pipe 64 above the first beam pipe 63 are arranged in parallel.

Both end surfaces in a lengthwise direction of the second beam pipe 64 are in contact with an opposing side surface 61a of the first column pipe 61 and an opposing side surface 62a of the second column pipe 62, respectively. The opposing side surface 61a of the first column pipe 61 is a side surface of the first column pipe 61 that faces the second column pipe 62. The opposing side surface 62a of the second column pipe 62 is a side surface of the second column pipe 62 that faces the first column pipe 61.

The reinforcing member 5 is fixed to at least the first beam pipe 63 and the second beam pipe 64. In the present embodiment, the reinforcing member 5 is also fixed to one of the first column pipe 61 and the second column pipe 62.

The reinforcing member 5 has a pair of plate-shaped beam contact portions 5c and a plate-shaped connecting portion 5a (see FIGS. 3 and 4). The pair of beam contact portions 5c come in contact with an upper surface of the first beam pipe 63 and a lower surface of the second beam pipe 64, respectively (see FIG. 3).

The connecting portion 5a is connected to the pair of beam contact portions 5c via a pair of first bent portions 5b that extend along the lengthwise direction of the first beam pipe 63 and the second beam pipe 64.

The second beam pipe 64, the pair of beam contact portions 5c, and the connecting portion 5a reinforces bending strength of the first beam pipe 63 when the image forming apparatus 10 is dropped. In a case of reducing weight of the structure 6 by using thin square pipes 60, the reinforcing member 5 increases the strength of the lower end portion of the structure 6 with a simple configuration.

The structure 6 further has a leg member 8a and a bracket 8b connected to a specific portion P1 that is part of the first beam pipe 63. Each of the leg member 8a and the bracket 8b protrudes downward from the specific portion P1 of the first beam pipe 63. Each of the leg member 8a and the bracket 8b is an example of a downward protruding member.

The leg member 8a has a threaded portion that is screwed into a screw hole in the first beam pipe 63, and a height of the downward protrusion from the first beam pipe 63 changes when the leg member 8a is rotated.

The structure 6 also has a plurality of casters 8c protruding downward from the first beam pipe 63 (see FIG. 3). The leg member 8a functions as a stopper that prevents the image forming apparatus 10 from moving due to the rolling of the casters 8c in the location where the image forming apparatus 10 is installed.

The bracket 8b is a sheet metal member to which other members (not shown) are attached. The bracket 8b is fixed to the first beam pipe 63 by screws or welding.

The leg member 8a and the bracket 8b are parts that are supported by packaging material when the image forming apparatus 10 is packaged. Therefore, in a case in which a package containing the image forming apparatus 10 falls, the first beam pipe 63 receives a particularly large force at the specific portion P1.

The reinforcing member 5 is arranged across a first reinforcing region A1 of the first beam pipe 63 and a second reinforcing region A2 of the second beam pipe 64 (see FIG. 3). The first reinforcing region A1 is a region that includes at least a part of the specific portion P1 of the first beam pipe 63. The second reinforcing region A2 is a region of the second beam pipe 64 that faces the first reinforcing region A1.

Therefore, the reinforcing member 5 effectively reinforces a region of the first beam pipe 63 that is likely to be subjected to a particularly large external force.

In the present embodiment, the reinforcing member 5 further includes a pair of plate-shaped beam fixing portions 5e (see FIGS. 3 and 4). The pair of beam fixing portions 5e are respectively connected to the pair of beam contact portions 5c via a pair of second bent portions 5d. The pair of second bent portions 5d are formed along the lengthwise direction of the first beam pipe 63 and the second beam pipe 64.

The pair of beam fixing portions 5e are fixed to outer side surfaces of the first beam pipe 63 and the second beam pipe 64, respectively (see FIG. 3). In the present embodiment, the pair of beam fixing portions 5e are fixed to the outer side surfaces of the first beam pipe 63 and the second beam pipe 64, respectively, by a plurality of screws 7a.

Note that the pair of beam fixing portions 5e may be fixed to the outer side surfaces of the first beam pipe 63 and the second beam pipe 64 by welding. In addition, when the pair of beam fixing portions 5e are omitted, the pair of beam contact portions 5c may be fixed to the upper surface of the first beam pipe 63 and the lower surface of the second beam pipe 64.

In the present embodiment, the structure 6 has two reinforcing members 5; one of the two reinforcing members 5 is fixed at a position along the first column pipe 61, and the other of the two reinforcing members 5 is fixed at a position along the second column pipe 62 (see FIG. 3).

Hereinafter, one of the two reinforcing members 5 that is a target of the description will be referred to as a target reinforcing member. In addition, of the first column pipe 61 and the second column pipe 62, one along which the target reinforcing member runs is referred to as a target column pipe, and the other is referred to as an opposing column pipe.

Each of the reinforcing members 5 has a plate-shaped supplemental portion 5g that is connected to the connecting portion 5a via a third bent portion 5f (see FIGS. 3 and 4). The third bent portion 5f of the target reinforcing member is formed along the lengthwise direction of the target column pipe.

In the target reinforcing member, the supplemental portion 5g is arranged along the opposing side surface 61a or 62a of the target column pipe that faces the opposing column pipe. The supplemental portion 5g reinforces the connecting portion 5a.

Furthermore, each reinforcing member 5 has a column fixing portion 5i that is connected to the supplemental portion 5g via a fourth bent portion 5h (see FIGS. 3 and 4). The fourth bent portion 5h of the target reinforcing member is formed along the lengthwise direction of the target column pipe.

In the target reinforcing member, the column fixing portion 5i is fixed to the outer side surface of the target column pipe (see FIG. 3). In the present embodiment, the column fixing portion 5i is fixed to the outer side surface of the target column pipe by a screw 7b.

Note that the column fixing portion 5i may be fixed to the outer side surface of the target column pipe by welding. In addition, in a case in which the column fixing portion 5i is omitted, the supplemental portion 5g may be fixed to the opposing side surface 61a or 62a of the target column pipe.

### Supplementary Notes

An outline of the technique according to the disclosure extracted from the above-described embodiments will be added below. Note that the configurations and processing functions described in the following supplementary notes can be selected and combined as desired.

### Supplementary Note 1

An image forming apparatus, including:
a printing device configured to form an image on a sheet; and
a structure configured to house the printing device; wherein
the structure includes:
a plurality of joined square pipes; and
a reinforcing member that is a sheet metal member fixed to a part of the plurality of square pipes;
the plurality of square pipes include:
a first column pipe and a second column pipe, each arranged along a vertical direction;
a first beam pipe joined to a lower end portion of the first column pipe and a lower end portion of the second column pipe; and
a second beam pipe joined to the first column pipe and the second column pipe above the first beam pipe; and
the reinforcing member has:
a pair of plate-shaped beam contact portions configured to contact an upper surface of the first beam pipe and a lower surface of the second beam pipe, respectively; and
a plate-shaped connecting portion connected to the pair of beam contact portions via a pair of first bent portions along a lengthwise direction of the first beam pipe and the second beam pipe.

### Supplementary Note 2

The image forming apparatus according to Supplementary Note 1, wherein
the reinforcing member is connected to the pair of beam contact portions via a pair of second bent portions along the lengthwise direction of the first beam pipe and the second beam pipe, and further has a pair of plate-shaped beam fixing portions fixed to outer side surfaces of the first beam pipe and the second beam pipe, respectively.

### Supplementary Note 3

The image forming apparatus according to Supplementary Notes 1 or 2, wherein
the reinforcing member is connected to the connecting portion via a third bent portion along a lengthwise direction of a target column pipe that is one of the first column pipe and the second column pipe, and further has a plate-shaped supplemental portion arranged along a side surface of the target column pipe facing the other of the first column pipe and the second column pipe.

### Supplementary Note 4

The image forming apparatus according to Supplementary Note 3, wherein
the reinforcing member further has a column fixing portion connected to the supplemental portion via a fourth bent portion along the lengthwise direction of the target column pipe and fixed to an outer side surface of the target column pipe.

### Supplementary Note 5

The image forming apparatus according to any one of Supplementary Notes 1 to 4, including
a downward protruding member that is connected to a specific portion that is a part of the first beam pipe and protrudes downward from the specific portion; wherein
the reinforcing member is arranged across a first reinforcing region that includes at least a part of the specific portion of the first beam pipe and a second reinforcing region that faces the first reinforcing region of the second beam pipe.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus, comprising:
a printing device configured to form an image on a sheet; and
a structure configured to house the printing device; wherein
the structure comprises:
a plurality of joined square pipes; and
a reinforcing member that is a sheet metal member fixed to a part of the plurality of square pipes;
the plurality of square pipes include:
a first column pipe and a second column pipe, each arranged along a vertical direction;
a first beam pipe joined to a lower end portion of the first column pipe and a lower end portion of the second column pipe; and
a second beam pipe joined to the first column pipe and the second column pipe above the first beam pipe; and
the reinforcing member has:
a pair of plate-shaped beam contact portions configured to contact an upper surface of the first beam pipe and a lower surface of the second beam pipe, respectively; and
a plate-shaped connecting portion connected to the pair of beam contact portions via a pair of first bent portions along a lengthwise direction of the first beam pipe and the second beam pipe.

2. The image forming apparatus according to claim 1, wherein
the reinforcing member is connected to the pair of beam contact portions via a pair of second bent portions along the lengthwise direction of the first beam pipe and the second beam pipe, and further has a pair of plate-shaped beam fixing portions fixed to outer side surfaces of the first beam pipe and the second beam pipe, respectively.

3. The image forming apparatus according to claim 1, wherein
the reinforcing member is connected to the connecting portion via a third bent portion along a lengthwise direction of a target column pipe that is one of the first column pipe and the second column pipe, and further has a plate-shaped supplemental portion arranged along a side surface of the target column pipe facing the other of the first column pipe and the second column pipe.

4. The image forming apparatus according to claim 3, wherein
the reinforcing member further has a column fixing portion connected to the supplemental portion via a fourth bent portion along the lengthwise direction of the target column pipe and fixed to an outer side surface of the target column pipe.

5. The image forming apparatus according to claim 1, comprising
a downward protruding member that is connected to a specific portion that is a part of the first beam pipe and protrudes downward from the specific portion; wherein
the reinforcing member is arranged across a first reinforcing region that includes at least a part of the specific portion of the first beam pipe and a second reinforcing region that faces the first reinforcing region of the second beam pipe.
